(19) United States
(12) Patent Application Publication
(10) Pub. No.: US 2015/0143991 A1
(43) Pub. Date: May 28, 2015

(54) MASTER CYLINDER WITH RECESSED PISTON-ROD INTERFACE

(71) Applicant: HB Performance Systems, Inc., Mequon, WI (US)

(72) Inventors: Steve Scheibe, Florence, WI (US); Noah C. Chapman, Milwaukee, WI (US)

(73) Assignee: HB Performance Systems, Inc., Mequon, WI (US)

(21) Appl. No.: 14/091,477

(22) Filed: Nov. 27, 2013

(51) Int. Cl. B60T 11/10; B60T 11/236

(52) U.S. Cl. CPC B60T 11/102; B60T 11/236
USPC 92/130 R

(57) ABSTRACT

A hydraulic brake assembly comprising a fluid conduit containing hydraulic fluid, a cylinder having a port fluidly connected to the conduit, and a piston positioned in the cylinder. The piston includes a recess having a depth at least 30% of a length of the piston. The assembly further includes a rod having an inner end positioned in the recess and an outer end outside the recess. In one embodiment, the piston moves relative to the cylinder along an axis, and the piston further includes a primary piston seal and a secondary piston seal separated by a seal spacing. The rod can axially overlap the secondary piston seal. For example, the inner end of the rod can be positioned axially between the primary piston seal and the secondary piston seal, and is preferably axially closer to the primary seal than to the secondary seal.

### BACKGROUND

The present invention relates generally to vehicle master cylinders (e.g., for hydraulic clutches or brakes) and more specifically to the interface between a piston and a rod in a master cylinder assembly.

Vehicles commonly use hydraulics to actuate certain vehicul components, such as clutches and brakes. In such hydraulic arrangements, a master cylinder is commonly used to pressurize the hydraulic fluid and thereby transmit force to a remote location.

Master cylinders typically include a main housing that defines a cylinder that retains fluid. A hydraulic piston is positioned in the cylinder and can reciprocate relative to the housing to force hydraulic fluid out of the housing. A spring is commonly used to bias the piston toward one end of the cylinder. A hydraulic rod includes an inner end that engages the piston and an outer end positioned outside the housing to facilitate movement of the piston from an external source. An actuator (e.g., a hand lever or foot pedal) can be used to provide the external force on the rod. With this arrangement, pressing on the actuator will provide movement to the rod and the piston, to thereby displace hydraulic fluid in the system.

### SUMMARY

The present invention provides a hydraulic brake assembly comprising a fluid conduit containing hydraulic fluid, a cylinder having a port fluidly connected to the conduit, and a piston positioned in the cylinder. The piston includes a recess having a depth that is at least 30% (preferably at least 50%) of a length of the piston. The assembly further includes a rod having an inner end positioned in the recess and an outer end outside the recess, and an actuator (e.g., a hand or foot lever) coupled to the outer end of the rod. If desired, the assembly can further include a reservoir fluidly coupled to the cylinder.

In one embodiment, the piston moves relative to the cylinder along an axis, and the piston further includes a primary piston seal and a secondary piston seal separated by a seal spacing. In this embodiment, the rod can axially overlap the secondary piston seal. For example, the inner end of the rod can be positioned axially between the primary piston seal and the secondary piston seal, and is preferably axially closer to the primary seal than to the secondary seal. In addition, the depth of the recess can be at least 70% (preferably at least 85% and more preferably at least 100%) of the seal spacing.

Other aspects of the invention will become apparent by consideration of the detailed description and accompanying drawings.

### BRIEF DESCRIPTION OF THE DRAWINGS

FIG. 1 illustrates a vehicle having a braking master cylinder assembly embodying the present invention.

FIG. 2 illustrates a brake master cylinder assembly from the ATV of FIG. 1.

FIG. 3 is an exploded view of the master cylinder assembly of FIG. 2.

FIG. 4 is a section view taken along line 4-4 in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

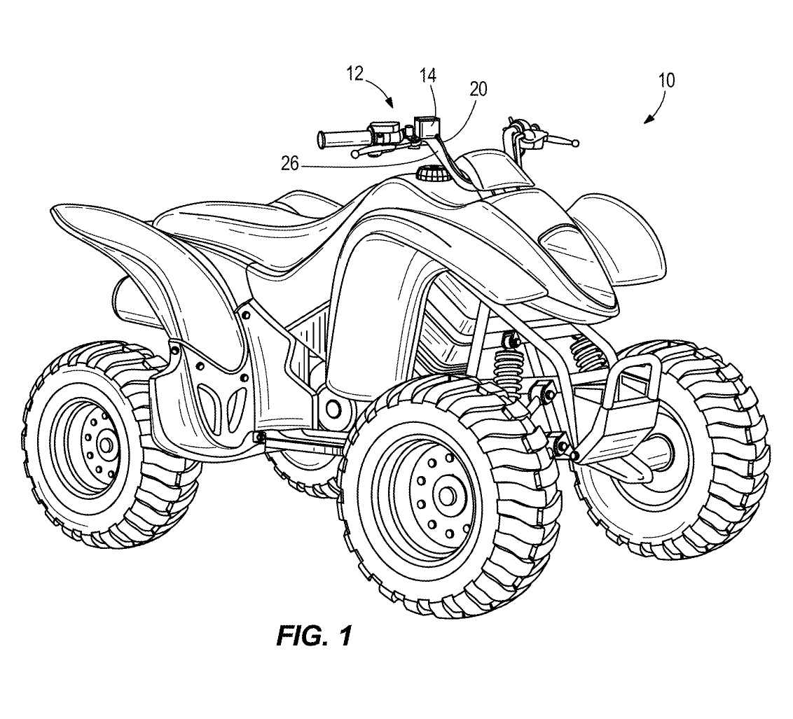

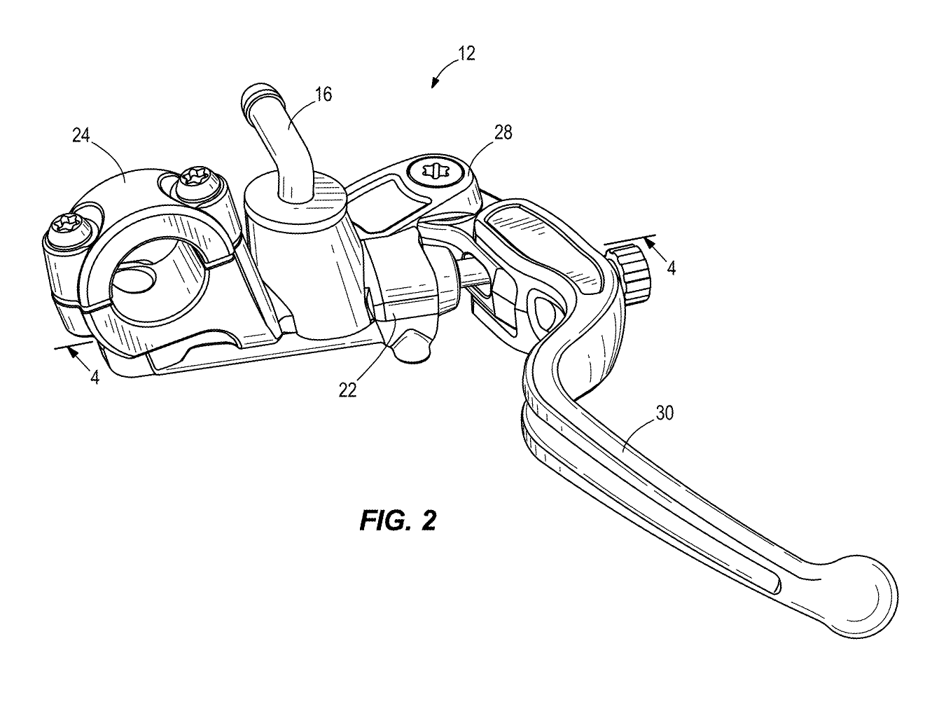

FIG. 1 illustrates an ATV 10 having a master cylinder assembly 12 embodying the present invention. The illustrated master cylinder assembly 12 is used in connection with a braking system to actuate the vehicle brakes. However, it should be understood that the features of the present invention are also applicable to a master cylinder assembly used in connection with other actuating systems, such as transmission clutches. The illustrated master cylinder assembly 12 is coupled to a fluid reservoir 14 by a reservoir conduit 16 (FIG. 2). The master cylinder assembly 12 provides pressurized fluid to a brake caliper (not shown) via a fluid conduit 20.

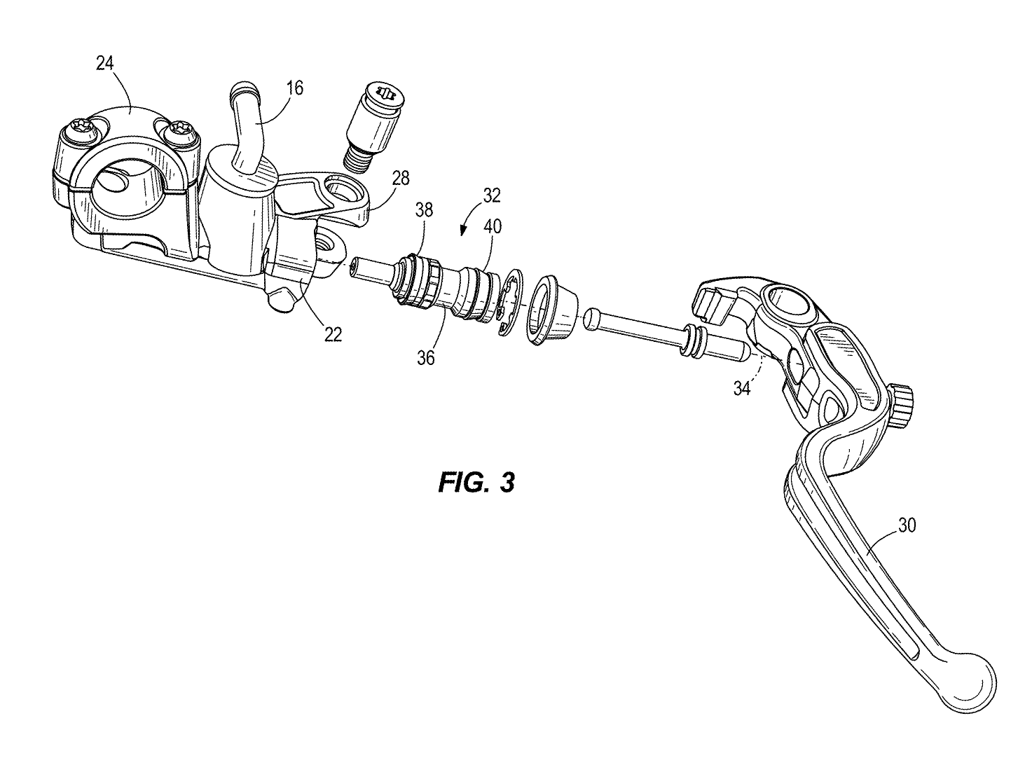

Referring to FIGS. 2-4, the illustrated master cylinder assembly 12 includes a cylinder housing 22 adapted to be mounted on the vehicle, such as by a clamping device 24 for clamping the cylinder housing 22 to a handlebar 26. The cylinder housing 22 defines a cylinder cavity 27 and further includes a lever support 28 that is pivotally coupled to an actuator, which in the illustrated embodiment is a brake lever 30. The brake lever 30 is adapted to be engaged by the user to actuate the braking system, as is known in the art.

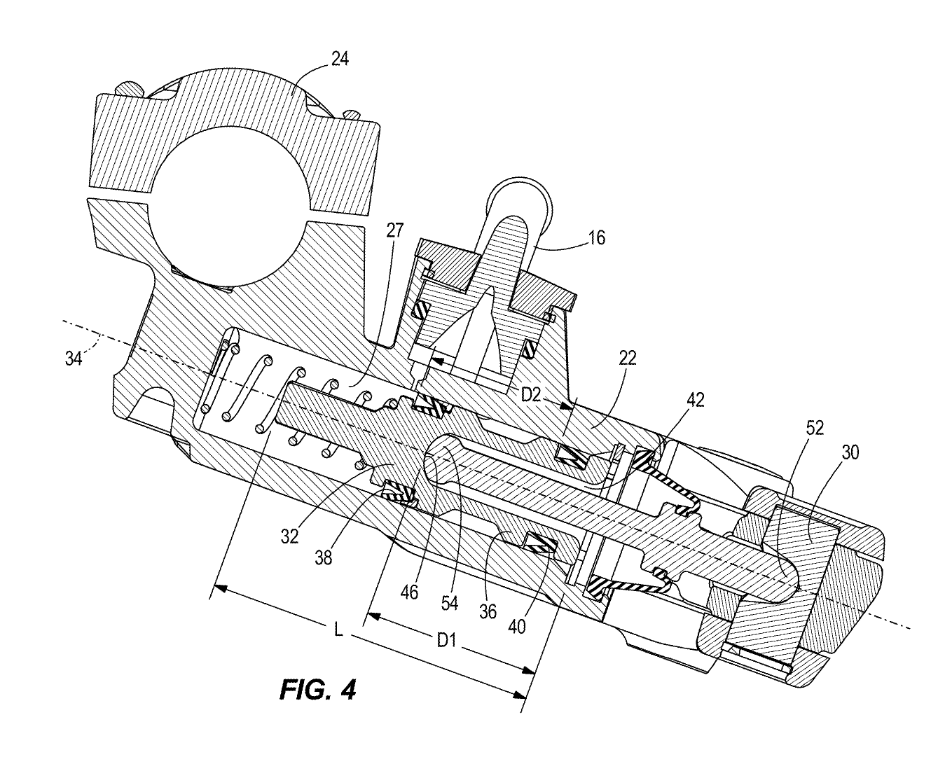

The master cylinder assembly 12 further includes a piston assembly 32 positioned in the cylinder housing 22 and adapted to reciprocate relative to the cylinder housing 22 along a piston axis 34. A piston return spring biases the piston toward the actuator. The piston assembly includes a piston body 36 and primary and secondary piston seals 38, 40 between the piston body 36 and the cylinder housing 22. The piston body 36 includes a deep recess 42 extending axially into an outer end of the piston body 36. The illustrated piston assembly 32 has an overall length L of 47.1 millimeters, and the illustrated recess 42 has a depth D1 of 25.3 millimeters. The primary and secondary piston seals 38,40 are spaced by a distance D2 of 21.5 millimeters. As shown in FIG. 4, the recess 42 has a bottom surface 46 that is positioned axially between the primary and the secondary piston seals 38,40.

In light of the above arrangement, it can be seen that the depth D1 of the recess 42 is greater than the distance D2 between the piston seals 38,40. In addition, it can be seen that the depth D1 of the recess 42 is greater than 50% of the overall length L of the piston body 36.

The master cylinder assembly 12 further includes a rod 50 positioned between the brake lever 30 and the piston body 36. An outer end 52 of the rod 50 engages the brake lever 30, and an inner end 54 of the rod 50 engages the bottom surface 46 of the recess 42 in the piston body 36. With this arrangement, it can be seen that the rod 50 axially overlaps (i.e., extends from one side to the other in the axial extent) the secondary piston seal 40. In other words, the secondary piston seal 40 defines a plane that is generally perpendicular to the piston axis 34, and one portion of the rod 50 is on one side of the plane and another portion of the rod 50 is on the other side of the plane. In addition, by virtue of the illustrated arrangement, the inner end 54 of the rod 50 is positioned axially between the primary and secondary piston seals 38,40, and is axially closer to the primary seal than to the secondary seal. That is, the primary and secondary seals 38,40 each define a plane substantially parallel to the piston axis 34, and the inner end 54 of the rod 50 is positioned between those two planes and is closer to the plane defined by the primary seal 38.

While the illustrated embodiment discloses an ATV, it should be understood that the features of the present invention can also be applied to other vehicles, such as motorcycles, bicycles, and snowmobiles.

1. A hydraulic brake assembly comprising:
a fluid conduit containing hydraulic fluid;
a cylinder having a port fluidly connected to the conduit;
a piston positioned in the cylinder, the piston having a length and including a recess having a depth that is at least 30% of the length of the piston;
a rod having an inner end positioned in the recess and an outer end outside the recess; and
an actuator coupled to the outer end of the rod.

2. A hydraulic brake assembly as claimed in claim 1, wherein the piston moves relative to the cylinder along an axis, wherein the piston further includes a piston seal, and wherein the rod axially overlaps the piston seal.

3. A hydraulic brake assembly as claimed in claim 1, wherein the piston moves relative to the cylinder along an axis, wherein the piston further includes a primary piston seal and a secondary piston seal, and wherein the rod axially overlaps the secondary piston seal.

4. A hydraulic brake assembly as claimed in claim 1, wherein the piston moves relative to the cylinder along an axis, wherein the piston further includes a primary piston seal and a secondary piston seal, and wherein the inner end of the rod is positioned axially between the primary piston seal and the secondary piston seal.

5. A hydraulic brake assembly as claimed in claim 1, wherein the piston moves relative to the cylinder along an axis, wherein the piston further includes a primary piston seal and a secondary piston seal axially spaced from the primary piston seal by a seal spacing, and wherein the depth of the recess is at least 70% of the seal spacing.

6. A hydraulic brake assembly as claimed in claim 1, wherein the piston moves relative to the cylinder along an axis, wherein the piston further includes a primary piston seal and a secondary piston seal axially spaced from the primary piston seal by a seal spacing, and wherein the depth of the recess is at least 85% of the seal spacing.

7. A hydraulic brake assembly as claimed in claim 1, wherein the piston moves relative to the cylinder along an axis, wherein the piston further includes a primary piston seal and a secondary piston seal axially spaced from the primary piston seal by a seal spacing, and wherein the recess has a depth that is at least 100% of the seal spacing.

8. A hydraulic brake assembly as claimed in claim 1, further comprising a reservoir fluidly coupled to the cylinder.

9. A hydraulic brake assembly as claimed in claim 1, wherein the actuator comprises a hand lever.

10. A hydraulic brake assembly as claimed in claim 1, wherein the depth of the recess is at least 50% of the length of the piston.

11. A hydraulic brake assembly comprising:
a fluid conduit containing hydraulic fluid;
a cylinder having a port fluidly connected to the conduit;
a piston positioned in the cylinder for movement along an axis, the piston including a piston seal;
a rod coupled to the piston and axially overlapping the piston seal; and
an actuator coupled to the outer end of the rod.

12. A hydraulic brake assembly as claimed in claim 11, wherein the piston includes a recess, and wherein the rod includes an inner end positioned in the recess and an outer end positioned out of the recess.

13. A hydraulic brake assembly as claimed in claim 11, further comprising a reservoir fluidly coupled to the cylinder.

14. A hydraulic brake assembly as claimed in claim 11, wherein the actuator comprises a hand lever.

15. A hydraulic brake assembly comprising:
a fluid conduit containing hydraulic fluid;
a cylinder having a port fluidly connected to the conduit;
a piston positioned in the cylinder for movement along an axis, the piston including a primary piston seal, a secondary piston seal, and a recess;
a rod having an inner end positioned in the recess and an outer end outside the recess, the inner end being positioned axially between the primary piston seal and the secondary piston seal; and
an actuator coupled to the outer end of the rod.

16. A hydraulic brake assembly as claimed in claim 15, wherein the inner end of the rod is axially closer to the primary piston seal than to the secondary piston seal.

17. A hydraulic brake assembly as claimed in claim 15, wherein the inner end of the rod is axially closer to the primary seal than to the secondary seal.

18. A hydraulic brake assembly as claimed in claim 15, further comprising a reservoir fluidly coupled to the cylinder.

19. A hydraulic brake assembly as claimed in claim 15, wherein the actuator comprises a hand lever.
